(19) United States
(12) Patent Application Publication
(10) Pub. No.: US 2010/0248022 A1
(43) Pub. Date: Sep. 30, 2010

(54) NONAQUEOUS ELECTROLYTE SECONDARY BATTERY

(75) Inventors: Hironori Shirakata, Itano-gun (JP); Yasunobu Iwami, Kobe-shi (JP); Masato Iwanaga, Itano-gun (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/721,928

(22) Filed: Mar. 11, 2010

(30) Foreign Application Priority Data
Mar. 26, 2009 (JP) 2009-076683

(51) Int. Cl. H01M 6/14

(52) U.S. Cl. 429/188

(57) ABSTRACT

The nonaqueous electrolyte secondary battery having high output characteristics and excellent safety when overcharging as well as excellent charge and discharge cycle characteristics according to an aspect of the invention includes a positive electrode having a positive electrode active material, a negative electrode having a negative electrode active material, a separator, and a nonaqueous electrolyte. The positive electrode active material includes lithium iron phosphate having an olivine crystal structure represented by General Formula LiₓFePO₄ (where x is 0<x<1.3), the negative electrode active material includes a carbon material having an average operating potential of 0.3 V or less based on lithium in a range of 10 to 30% depth of discharge at the time of discharging at 6 mA/cm², and the nonaqueous electrolyte includes an alkoxybenzene derivative within a range of 0.1 to 5.0% by mass.

### TECHNICAL FIELD

The present invention relates to a nonaqueous electrolyte secondary battery and, in particular, relates to a nonaqueous electrolyte secondary battery that uses lithium iron phosphate having an olivine crystal structure as the positive electrode active material and that has high output characteristics and excellent safety when overcharging as well as excellent charge and discharge cycle characteristics.

### BACKGROUND ART

Recently, as a power supply for driving portable electronic equipment such as cell phones, portable personal computers, and portable music players, and further, as a power supply for power tools, hybrid electric vehicles (HEVs), and electric vehicles (EVs), nonaqueous electrolyte secondary batteries represented by a lithium ion secondary battery having high energy density and high capacity are widely used. Among them, nonaqueous electrolyte secondary batteries using graphite particles as the negative electrode active material are widely used because of their high safety and high capacity.

As for the positive electrode active material in these nonaqueous electrolyte secondary batteries, one of or a mixture of a plurality of lithium transition-metal composite oxides capable of absorbing and desorbing lithium ions reversibly, that is, LiCoO₂, LiNiO₂, LiNiₓCo₁₋ₓO₂ (x=0.01 to 0.99), LiMnO₂, LiMn₂O₄, LiCoₓMn_{y}Ni_{z}O₂ (x+y+z=1), lithium iron phosphate, or the like, is used.

Among the positive electrode active material, the lithium-cobalt composite oxide is frequently used because its various battery characteristics are especially higher than those of other oxides. However, the lithium-cobalt composite oxide has problems that cobalt is expensive, the amount of cobalt in natural resources is small, and moreover, the thermal stability of lithium-cobalt composite oxide decreases when overcharging. Thus, various benzenes are commonly added to the nonaqueous electrolyte in order to inhibit abnormality of the nonaqueous electrolyte secondary battery when overcharging (see JP-A-09-050822 and JP-A-10-189044).

On the other hand, in the recent applications of power tools, EVs, HEVs, and the like, because charging and discharging at high current is required, lithium iron phosphate having an olivine crystal structure which has higher thermal stability than that of the lithium-cobalt composite oxide, has also become to be used (see JP-A-2002-075364 and JP-A-2003-242974). Such lithium iron phosphate having an olivine crystal structure is a compound represented by General Formula LiₓFePO₄ (where x is 0<x<1.3). Having high output characteristics as well as including iron and phosphorus which are widely available as natural resources and cheap, as the constituents, such lithium iron phosphate has features of lower-cost and less environmental impact than lithium-cobalt composite oxides.

As discussed above, though nonaqueous electrolyte secondary batteries have technically improved in various ways in order to improve the thermal stability and output characteristics, even higher safety and better output characteristics are required in the recent market of the power tools, HEVs, EVs, and the like. Such requirements are the same for lithium iron phosphate which is known to have high output characteristics as well as very high thermal stability. Lithium iron phosphate has the problem of not matching the reaction potential of related art overcharge additives because it has a lower charging potential than that of related art transition-metal oxides containing lithium. For example, cyclohexylbenzene derivatives effectively work as the overcharge protection additive in the nonaqueous electrolyte secondary battery using a related art transition-metal oxide containing lithium as the positive electrode active material. In contrast, cyclohexylbenzene derivatives have an insufficient function as the overcharge protection additive in the nonaqueous electrolyte secondary battery using lithium iron phosphate as the positive electrode active material because the degradation timing when overcharging is less different from the degradation timing of the nonaqueous electrolyte itself.

Furthermore, Journal of Power Sources, 162 (2006) 1379-1394 suggests, for example, that anisole compounds can be used as the overcharge protection additive, and that anisole is suitable as the overcharge protection additive for nonaqueous electrolyte secondary batteries using lithium iron phosphate as the positive electrode active material because anisole has a low reaction potential. However, according to the experimental results obtained by the inventors, when using lithium iron phosphate having an olivine crystal structure as the positive electrode active material, using a commonly used carbon material as the negative electrode active material, and using anisole as the overcharge protection additive, the amount of gas generation is so large when overcharging that only unsatisfactory results are obtained.

The inventors have studied in various ways in order to solve the problems when using such lithium iron phosphate having an olivine crystal structure as the positive electrode active material, using a commonly used carbon material as the negative electrode active material, and adding an alkoxybenzene derivative such as anisole in the nonaqueous electrolyte, and, as a result, have found the main cause that, when overcharging, the potential of the negative electrode is so low that the alkoxybenzene derivative such as anisole degrades not only oxidatively on a surface of the positive electrode but also reductively on a surface of the negative electrode.

### SUMMARY

An advantage of some aspects of the present invention is to provide, in a nonaqueous electrolyte secondary battery using lithium iron phosphate having an olivine crystal structure as the positive electrode active material and a carbon material as the negative electrode active material, the nonaqueous electrolyte secondary battery having high output characteristics and excellent safety when overcharging as well as excellent charge and discharge cycle characteristics.

According to an aspect of the invention, a nonaqueous electrolyte secondary battery includes a positive electrode having a positive electrode active material, a negative electrode having a negative electrode active material, a separator, and a nonaqueous electrolyte. The positive electrode active material includes lithium iron phosphate with an olivine crystal structure represented by General Formula LiₓFePO₄ (where x is 0<x<1.3), the negative electrode active material includes a carbon material with an average operating potential of 0.3 V or less based on lithium (vs. Li⁺/Li) in a range of 10 to 30% depth of discharge at the time of discharging at 6 mA/cm², and the nonaqueous electrolyte includes an alkoxybenzene derivative within a range of 0.1% by mass to 5.0% by mass.

For a negative electrode using a carbonaceous material commonly used as the negative electrode active material of the nonaqueous electrolyte secondary battery, for example, the negative electrode using synthetic graphite has an average operating potential over 0.3 V in a range of 10 to 30% depth of discharge at the time of discharging at 6 mA/cm². Here, the condition of “at the time of discharging at 6 mA/cm²” is the average discharge current density at the time of high current discharging in the applications of power tools and the like. Furthermore, under the condition of “in a range of 10 to 30% depth of discharge”, the potential can be readily measured because of the stable potential at the time of discharging in the range.

In a negative electrode having an operating potential over 0.3 V at the time of common current discharging, the overvoltage is so high that the potential largely decreases at the time of charging. Consequently, the potential of the negative electrode decreases so much when overcharging that the alkoxybenzene derivative added as the overcharge protection additive reductively degrades on the surface of the negative electrode. Therefore, in a nonaqueous electrolyte secondary battery using the negative electrode having an operating potential over 0.3 V at the time of common current discharging in combination with the positive electrode active material including lithium iron phosphate having an olivine crystal structure represented by General Formula, the alkoxybenzene derivative reductively degrades on the surface of the negative electrode when overcharging to generate so much gas that not only a current interrupting device used in a common nonaqueous electrolyte secondary battery but also a safety valve work.

In contrast, in a negative electrode having an operating potential of 0.3 V or less at the time of common current discharging, because the overvoltage is low and the potential of the negative electrode decreases a little at the time of charging, the reductive degradation of the alkoxybenzene derivative added as the overcharge protection additive on the surface of the negative electrode is inhibited even when overcharging. In the nonaqueous electrolyte secondary battery according to the present aspect of the invention, because the negative electrode having an operating potential of 0.3 V or less at the time of common current discharging is used in combination with the positive electrode active material including lithium iron phosphate having an olivine crystal structure represented by General Formula, the alkoxybenzene derivative does not reductively degrade on the surface of the negative electrode but oxidatively degrades on the surface of the positive electrode when overcharging. Thus, with the nonaqueous electrolyte secondary battery according to the present aspect of the invention, because the alkoxybenzene derivative mainly oxidatively degrades the surface of the positive electrode when overcharging, the timing and amount of gas generation can become best suited for protecting the overcharge to effectively actuate only the current interrupting device, and thus, the nonaqueous electrolyte secondary battery with excellent safety when overcharging can be obtained.

Here, the discharge current density and operating potential of the negative electrode can be easily measured with a single electrode cell produced with a counter electrode and reference electrode using lithium metal. Furthermore, examples of the alkoxybenzene derivative capable of being used in the invention include anisole (C₆H₅—OCH₃), 1,4-dimethoxybenzene (C₆H₄—(OCH₃)₂), and 2-bromo-1,4-dimethoxybenzene ((C₆H₃Br—(OCH₃)₂), and specifically preferred is anisole.

Furthermore, the addition amount of the alkoxybenzene derivative used in the invention needs to be within a range of 0.1% by mass to 5.0% by mass with respect to the nonaqueous electrolyte. It is not preferable that the addition amount of the alkoxybenzene derivative is less than 0.1% by mass with respect to the nonaqueous electrolyte because the characteristic as the overcharge protection additive does not appear, and that the amount exceeds 5.0% by mass with respect to the nonaqueous electrolyte because the charge and discharge cycle characteristics decrease.

As for a nonaqueous solvent (organic solvent) included in the nonaqueous electrolyte capable of being used in the nonaqueous electrolyte secondary battery according to the present aspect of the invention, carbonates, lactones, ethers, esters, and the like can be used, and a mixture of two or more kinds of these solvents can be used. Among them, specifically preferred is a mixture of a cyclic carbonate and acyclic carbonate.

Specific examples of the nonaqueous solvent include ethylene carbonate (EC), propylene carbonate (PC), butylene carbonate (BC), cyclopentanone, sulfolane, 3-methylsulfolane, 2,4-dimethylsulfolane, 3-methyl-1,3-oxazolidin-2-one, dimethyl carbonate (DMC), methyl ethyl carbonate (MEC), diethyl carbonate (DEC), methyl propyl carbonate, methyl butyl carbonate, ethyl propyl carbonate, ethyl butyl carbonate, dipropyl carbonate, γ-butyrolactone, γ-valerolactone, 1,2-dimethoxyethane, tetrahydrofuran, 2-methyltetrahydrofuran, 1,3-dioxolane, methyl acetate, ethyl acetate, and 1,4-dioxane.

As for a solute of the nonaqueous electrolyte in the invention, lithium salts commonly used as the solute in the nonaqueous electrolyte secondary battery can be used. Examples of such lithium salt include LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂, and a mixture thereof. Among them, LiPF₆ (lithium hexafluorophosphate) is preferably used. The dissolution amount of the solute is preferably 0.5 to 2.0 mol/L with respect to the nonaqueous solvent.

Furthermore, in the nonaqueous electrolyte secondary battery according to the present aspect of the invention, it is preferable that the negative electrode active material is natural graphite or artificial graphite coated with amorphous carbon.

Most of the natural graphite can be used as the negative electrode active material of the nonaqueous electrolyte secondary battery according to the present aspect of the invention because of having an average operating potential of 0.3 V or less based on lithium in a range of 10 to 30% depth of discharge at the time of discharging at 6 mA/cm². Furthermore, though the artificial graphite itself has an average operating potential over 0.3 V based on lithium in a range of 10 to 30% depth of discharge at the time of discharging at 6 mA/cm², the artificial graphite coated with amorphous carbon which is obtained by coating the surface of the artificial graphite with amorphous carbon material such as pitch and then treating it with heat has an average operating potential of 0.3 V or less. Thus, the artificial graphite coated with amorphous carbon can be used as the negative electrode active material of the nonaqueous electrolyte secondary battery according to the present aspect of the invention.

Furthermore, in the nonaqueous electrolyte secondary battery according to the present aspect of the invention, the final charge voltage is preferably 3.5 to 4.0 V. In the nonaqueous electrolyte secondary battery according to the present aspect of the invention, because the positive electrode active material includes lithium iron phosphate having an olivine crystal structure represented by General Formula, and because the negative electrode active material includes such above carbonaceous material, when the nonaqueous electrolyte secondary battery according to the present aspect of the invention is charged at a high voltage of 4.2 V in a similar manner as in the commonly used nonaqueous electrolyte secondary battery using a transition-metal oxide containing lithium as the positive electrode active material, the charge and discharge cycle characteristics decrease. In the nonaqueous electrolyte secondary battery according to the present aspect of the invention, when the final charge voltage is reduced to 3.5 to 4.0 V, the charge and discharge cycle characteristics do not decrease, and consequently, the nonaqueous electrolyte secondary battery with high power and excellent overcharge characteristics as mentioned above can be obtained. The most preferred final charge voltage is 3.6 to 3.8 V.

### BRIEF DESCRIPTION OF THE DRAWINGS

The invention will be described with reference to the accompanying drawings, wherein like numbers reference like elements.

FIG. 1 is a perspective view showing a longitudinal section of a cylindrical-shaped nonaqueous electrolyte secondary battery used in each of Examples and Comparative Examples.

FIG. 2 is a schematic view showing the structure of a single electrode cell.

### DESCRIPTION OF EXEMPLARY EMBODIMENTS

Hereinafter, exemplary embodiments of the invention will be described in detail with examples and comparative examples. However, the examples described below are an illustrative example of nonaqueous electrolyte secondary batteries for embodying the technical spirit of the invention, and are not intended to limit the invention to the examples, and the invention may be equally applied to various modified batteries without departing from the technical spirit described in the claims.

First, a specific producing method of the nonaqueous electrolyte secondary battery used in each of Examples 1 to 5 and Comparative Examples 1 to 5 will be described.

### Manufacture of Positive Electrode

Lithium iron phosphate having an olivine crystal structure represented by General Formula of LiFePO₄ and having an average particle diameter of 100 nm was manufactured to be used. Then, 85 parts by mass of the positive electrode active material including the lithium iron phosphate manufactured as above, 10 parts by mass of carbon powder as a conductive material, and 5 parts by mass of polyvinylidene fluoride powder as a binder were mixed and then the whole was mixed with a solution of N-methyl-2-pyrrolidone (NMP) to prepare slurry. The slurry was coated on both sides of an aluminum collector with a thickness of 20 μm by a doctor blade method to form positive electrode active material mixture layers. Subsequently, the positive electrode was compressed with a compression roller to manufacture a positive electrode with a short side length of 55 mm and a long side length of 750 mm to be used in Examples 1 to 5 and Comparative Examples 1 to 5.

### Manufacture of Negative Electrode

Three types of negative electrode active materials, that is, natural graphite, artificial graphite, and artificial graphite coated with amorphous carbon on the surface were prepared and used according to each of Examples and Comparative Examples. The artificial graphite coated with amorphous carbon on the surface was prepared as follows. First, an artificial graphite powder with an average particle diameter of 20 μm was prepared as the carbonaceous material to be the core. A petroleum pitch (a softening point of 250° C.) was prepared as a carbon precursor for coating the surface of the core to be the amorphous carbon. These artificial graphite powder and petroleum pitch were mixed, and the mixture was kneaded under heat and nitrogen gas atmosphere, kept at 1000° C. for 3 hours, and then cooled to room temperature to obtain a carbon composite material in which the coating layer of the amorphous carbon was formed on the surface of the core of the artificial graphite particle. Here, all of the negative electrode active materials including the artificial graphite coated with amorphous carbon on the surface used in Examples 2 to 5 were the same, and all of the negative electrode active materials including the artificial graphite used in Comparative Examples 1, 2, and 4 were the same.

The negative electrode was manufactured as follows. First, 98 parts by mass of the negative electrode active material, 1 part by mass of styrene-butadiene rubber as a binder, and 1 part by mass of carboxymethyl cellulose as a thickener were mixed and then the whole was mixed with water to prepare slurry. The slurry was coated on both sides of a copper collector with a thickness of 10 μm by a doctor blade method to form negative electrode active material mixture layers. Subsequently, the negative electrode was compressed with a compression roller to a predetermined density to manufacture a negative electrode with a short side length of 57 mm and a long side length of 800 mm.

### Manufacture of Nonaqueous Electrolyte

To a mixed solvent of equal volumes of ethylene carbonate and diethyl carbonate, LiPF₆ was dissolved so as to be 1.6 mol/L to give an electrolyte for manufacturing the batteries. Anisole (Examples 1 to 5 and Comparative Examples 3 to 5) or cyclohexylbenzene (Comparative Example 2) as the alkoxybenzene derivative was mixed so as to be a predetermined ratio with respect to 100 parts by mass of the electrolyte to prepare each nonaqueous electrolyte of Examples 1 to 5 and Comparative Examples 1 to 5.

### Manufacture of Battery

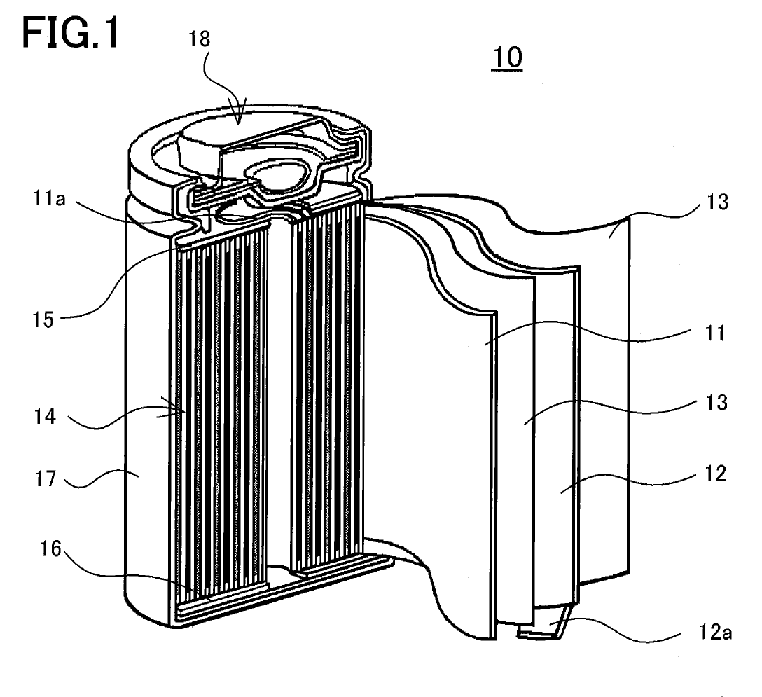

Using the positive electrode, negative electrode, and nonaqueous electrolyte manufactured as above, each cylindrical-shaped nonaqueous electrolyte secondary battery (a height of 650 mm, a diameter of 18 mm) of Examples 1 to 5 and Comparative Examples 1 to 5 was manufactured. Here, a polypropylene microporous membrane was used as the separator. A specific structure of the cylindrical-shaped nonaqueous electrolyte secondary battery is shown in FIG. 1. Here, FIG. 1 is a perspective view showing a longitudinal section of the cylindrical-shaped nonaqueous electrolyte secondary battery used in each of Examples 1 to 5 and Comparative Examples 1 to 5. A nonaqueous electrolyte secondary battery 10 used a rolled electrode assembly 14 formed by rolling a positive electrode 11 and a negative electrode 12 interposing a separator 13 therebetween and had the following structure: insulting plates 15 and 16 were placed on upper and lower faces of the rolled electrode assembly 14, respectively, and then the rolled electrode assembly 14 was put into a cylindrical-shaped battery outer can 17 made of steel also serving as a negative electrode terminal.

Then, a current collecting tab 12a of the negative electrode 12 was welded on an inner bottom part of the battery outer can 17 and also a current collecting tab 11a of the positive electrode 11 was welded on a bottom plate part of a current interrupting sealing body 18 equipping a safety apparatus. A predetermined nonaqueous electrolyte was poured from a mouth portion of the battery outer can 17, then the battery outer can 17 was sealed with the sealing body 18 equipped with a safety valve and current interrupting device. The obtained nonaqueous electrolyte secondary battery had a rated capacity of 1000 mAh. Each nonaqueous electrolyte secondary battery of Examples 1 to 5 and Comparative Examples 1 to 5 was made to be negative electrode capacity/positive electrode capacity=1.1.

### Measurement of Charge and Discharge Cycle Characteristics

Each battery of Examples 1 to 5 and Comparative Examples 1 to 4 was charged at 25° C. and at a constant current of 1 It=1000 mA until the battery voltage reached 3.6 V, and after reaching a battery voltage of 3.6 V, the battery was charged at a constant voltage of 3.6 V until the charging current reached 20 mA. Subsequently, the battery was discharged at a constant current of 10 It=10000 mA until the battery voltage reached 2.0 V. This charging and discharging was regarded as one cycle and repeated 300 times, and the rate (%) of the discharge capacity of the 300th cycle with respect to that of the first cycle was calculated as the charge and discharge cycle characteristics. The concluded results are shown in Table 1.

### Measurement of Overcharge Characteristics

Each battery of Examples 1 to 5 and Comparative Examples 1 to 4 was charged at 25° C. and at constant currents of 3 It=3000 mA, 4 It=4000 mA, or 5 It=5000 mA until the current interrupting device worked. The concluded results are shown in Table 1 where “A” represents that only the current interrupting device worked and the safety valve did not work, “B” represents that both the current interrupting device and safety valve worked, and “C” represents that the battery was exploded or burned.

### Manufacture of Single Electrode Cell

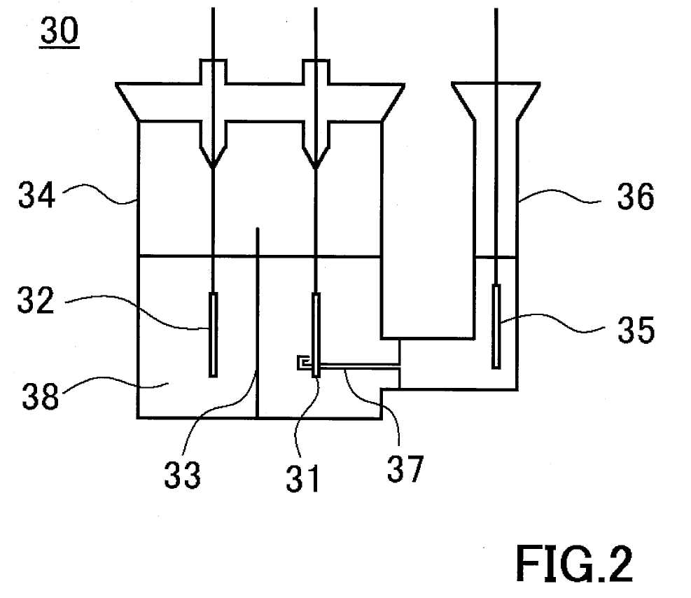

One of the surfaces of each negative electrode of Comparative Example 3, Example 1, and 2 was peeled away, and the resultant electrode was cut out so that the area of the negative electrode active material mixture layer became 10 cm². The cut out electrode was used as a work electrode to manufacture a single electrode cell 30 shown in FIG. 2 and the charge and discharge test was carried out. Metallic lithium plates were used as the counter electrode and reference electrode, and the metallic lithium plates were cut into a size capable of opposing the negative electrode material to be used. Furthermore, as the nonaqueous electrolyte, to a mixed solvent of equal volumes of ethylene carbonate and diethyl carbonate, LiPF₆ was dissolved so as to be 1.6 mol/L, and then 2% by mass of anisole was added to be used. Here, as the separator, a polypropylene microporous membrane was used.

As shown in FIG. 2, the single electrode cell 30 was composed of a measurement vessel 34 in which a work electrode 31, a counter electrode 32, and a separator 33 were placed and a reference electrode vessel 36 in which a reference electrode 35 was placed. Then, a capillary 37 extended from the reference electrode vessel 36 to near the surface of the work electrode 31, and both of the measurement vessel 34 and reference electrode vessel 36 were filled with a nonaqueous electrolyte 38. Both of the counter electrode 31 and reference electrode 35 employed lithium metal. Hereinafter, each potential represents the potential with respect to Li of the reference electrode 35.

First, the cell was charged at 25° C. using each negative electrode at 1 mA/cm² until reaching 0.0 V based on lithium, then suspended for 10 minutes, and thereafter discharged at 1 mA/cm² until reaching 1.0 V based on lithium. This cycle was repeated three times. Next, the cell was charged at 1 mA/cm² until reaching 0.0 V based on lithium, then the average operating potential in a range of 10 to 30% depth of discharge (DOD) at the time of discharging at 6 mA/cm² was measured as the average discharging potential. The concluded results are shown in Table 1.

TABLE 1

| | Negative | | Average | | Amount of |
|---|---|---|---|---|---|
| | electrode | Amorphous | discharging | | additive |
| | active | carbon | potential | | added (% |
| | material | coating | (vs. Li⁺/Li) | Additive type | by mass) |
| Comparative | Artificial | Coated | 0.28 | None | — |
| Example 1 | graphite | | | | |
| Comparative | Artificial | Coated | 0.28 | Cyclohexylbenzene | 2 |
| Example 2 | graphite | | | | |
| Comparative | Artificial | None | 0.32 | Anisole | 2 |
| Example 3 | graphite | | | | |
| Example 1 | Natural | None | 0.27 | Anisole | 2 |
| | graphite | | | | |
| Example 2 | Artificial | Coated | 0.28 | Anisole | 2 |
| | graphite | | | | |
| Example 3 | Artificial | Coated | 0.28 | Anisole | 0.5 |
| | graphite | | | | |
| Example 4 | Artificial | Coated | 0.28 | Anisole | 3 |
| | graphite | | | | |
| Example 5 | Artificial | Coated | 0.28 | Anisole | 5 |
| | graphite | | | | |
| Comparative | Artificial | Coated | 0.28 | Anisole | 6 |
| Example 4 | graphite | | | | |

| | | | | Cycle |
|---|---|---|---|---|
| | 3 A overcharge | 4 A overcharge | 5 A overcharge | characteristics (%) |
| Comparative | B | B | B | 83 |
| Example 1 | | | | |
| Comparative | A | B | B | 83 |
| Example 2 | | | | |
| Comparative | A | B | B | 84 |
| Example 3 | | | | |
| Example 1 | A | A | B | 83 |
| Example 2 | A | A | A | 83 |
| Example 3 | A | A | A | 83 |
| Example 4 | A | A | A | 83 |
| Example 5 | A | A | A | 81 |
| Comparative | A | A | A | 78 |
| Example 4 | | | | |

The results shown in Table 1 reveal the following. First, from the test results by the single electrode cell using each negative electrode of Comparative Example 3, Example 1, and 2, the average operating potential (based on lithium) in a range of 10 to 30% DOD at the time of discharging at 6 mA/cm² of the artificial graphite itself (Comparative Example 3) was 0.32 V, but that of the artificial graphite coated with amorphous carbon on the surface (Example 2) was as low as 0.28 V. The average operating potential of the natural graphite was 0.27 V. Here, all of the negative electrode active materials including the artificial graphite coated with amorphous carbon on the surface used in Examples 3 to 5 and Comparative Examples 1, 2, and 4 were the same as that in Example 2.

As shown in Examples 1 to 5, it is revealed that, when using the negative electrode including, as the negative electrode active material, the carbon material with an average operating potential of 0.30 V or less based on lithium in a range of 10 to 30% DOD at the time of discharging at 6 mA/cm², and when including anisole with a content of 0.5 to 5% by mass, excellent overcharge characteristics were exhibited. In particular, when using the graphite coated with the amorphous carbon as the negative electrode active material (Examples 2 to 5), more excellent overcharge characteristics were exhibited than those when using the natural graphite (Example 1). As shown in Comparative Examples 1 to 3, it is clear that, when either the carbon negative electrode with an average operating potential of 0.3 V or less based on lithium in a range of 10 to 30%. DOD at the time of discharging at 6 mA/cm² or anisole was absent, the overcharge characteristics were inferior as compared with those in Examples 1 to 5. Furthermore, as shown in Comparative Example 4, it is found that, when including anisole with a content of 6% by mass, the cycle characteristics decreased. Such phenomena are assumed because the addition amount of anisole is so high that the concentration of the electrolyte decreases relatively.

From these results, it is clear that, when using the positive electrode including lithium iron phosphate with an olivine crystal structure as the positive electrode active material, the negative electrode including, as the negative electrode active material, the carbon material with an average operating potential of 0.30 V or less based on lithium in a range of 10 to 30% DOD at the time of discharging at 6 mA/cm², and the nonaqueous electrolyte including anisole with a content of 0.5 to 5% by mass, fine overcharge characteristics and charge and discharge cycle characteristics are obtained. In Examples 1 to 5, anisole used as the additive was exemplified, but alkoxybenzene derivatives such as 1,4-dimethoxybenzene and 2-bromo-1,4-dimethoxybenzene which have similar oxidation-reduction potentials, can be equally used.

Test with Respect to Charging Voltage

Hereinafter, as Comparative Example 5, the effect on the cycle characteristics by varying charging voltage was measured. The nonaqueous electrolyte secondary battery having the same structure as that in Example 2 was charged at 25° C. and at a constant current of 1 It=1000 mA until the battery voltage reached 4.2 V, and after reaching a battery voltage of 4.2 V, the battery was charged at a constant voltage of 4.2 V until the charging current reached 20 mA. Subsequently, the battery was discharged at a constant current of 10 It=10000 mA until the battery voltage reached 2.0 V. This charging and discharging was regarded as one cycle and repeated 300 times, and the rate (%) of the discharging capacity of the 300th cycle with respect to that of the first cycle was calculated as the charge and discharge cycle characteristics. The result is shown in Table 2 accompanied with the result of Example 2.

TABLE 2

| | | | | Amount of | | |
|---|---|---|---|---|---|---|
| | Negative | | | anisole | | |
| | electrode | Amorphous | discharging | added | Charging | Cycle |
| | active | carbon | potential | (% by | voltage | characteristics |
| | material | coating | (vs. Li⁺/Li) | mass) | (V) | (%) |
| Example 2 | Artificial | Coated | 0.28 | 2 | 3.6 | 83 |
| | graphite | | | | | |
| Comparative | Artificial | Coated | 0.28 | 2 | 4.2 | 76 |
| Example 5 | graphite | | | | | |

As shown in Comparative Example 5, when charging at a high voltage of 4.2 V in a similar manner as in the commonly used nonaqueous electrolyte secondary battery using a transition-metal oxide containing lithium as the positive electrode active material, the charge and discharge cycle characteristics decreased as compared with the result of Example 2 where the final charge voltage was 3.6 V. The results reveal that the charge and discharge cycle characteristics are effectively improved by the addition of the alkoxybenzene derivative such as anisole only when lithium iron phosphate with a low charging voltage is combined. Such phenomena are assumed because, when the charging voltage is high, the alkoxybenzene derivative is oxidized on the surface of the positive electrode even at the time of usual charging. Thus, in the nonaqueous electrolyte secondary battery according to the present aspect of the invention, it is revealed that the final charge voltage is preferably 3.5 to 4.0 V and especially preferably 3.6 to 3.8 V.

What is claimed is:

1. A nonaqueous electrolyte secondary battery comprising:
a positive electrode including a positive electrode active material;
a negative electrode including a negative electrode active material;
a separator; and
a nonaqueous electrolyte;
the positive electrode active material having lithium iron phosphate with an olivine crystal structure represented by General Formula LiₓFePO₄ (where x is 0<x<1.3);
the negative electrode active material having a carbon material with an average operating potential of 0.3 V or less based on lithium in a range of 10 to 30% depth of discharge at the time of discharging at 6 mA/cm²; and
the nonaqueous electrolyte including an alkoxybenzene derivative within a range of 0.1% by mass to 5.0% by mass.

2. The nonaqueous electrolyte secondary battery according to claim 1, wherein the negative electrode active material is natural graphite or artificial graphite coated with amorphous carbon.
